(19) United States
(12) Patent Application Publication
(10) Pub. No.: US 2002/0139852 A1
(43) Pub. Date: Oct. 3, 2002

(54) Casing structure of image reader

(76) Inventor: Eiichi Hayashi, Saitama-shi (JP)

Correspondence Address: H. W. Reick, 695 Kenmoor, S.E., Post Office Box 2567, Grand Rapids, MI, 49501, US

(21) Appl. No.: 10/106,648

(22) Filed: Mar. 26, 2002

(30) Foreign Application Priority Data
Mar. 30, 2001 (JP) 2001-102632

(51) Int. Cl. G06K 7/10; G06K 7/14

(52) U.S. Cl. 235/454

(57) ABSTRACT

A casing for an image reader includes wall which are welded together and thus the labor of assembly is reduced. The casing includes a main casing which accommodates the carriage and the like, and a secondary casing beneath the main casing which accommodates control circuits. Thus, the image reader may be used with various types of image processing devices, such as copy machines, scanners, or the like.

### BACKGROUND OF THE INVENTION

1. Field of the Invention

The present invention relates a casing structure for a stationary original type image reader.

2. Description of the Related Art

In an image reader such as copying machines, printers, scanners and the like in which image data of an original which is displayed on a sheet of paper or the like is read and various processes are carried out, light beams emitted from a light source lamp such as a fluorescent lamp or the like is irradiated onto the original, and the reflected light beams are made incident on a light receiving station having a photoelectric converter device such as a CCD (Charge-Coupled Device) or the like. In the image reader of the stationary original type, the light source lamp is moved with respect to the original which is placed on the platen glass, while the light beams from the light source lamp is irradiated onto the original. Moreover, since the optical path length from the original to the light receiving station must be kept even when the position of the original being irradiated changes, an appropriate number of reflectors are used to lead the light beams from the light source lamp to a photoelectric converter device as the light source lamp and the reflectors are moved along the original.

FIG. 11 is a perspective view of the schematic structure of the image reader 1 of the above-described type. Support plate portions 2p are formed of step portions at the inner sides of side walls 2a and 2b which extend in the longitudinal direction of a casing 2 of an image reader 1. A fall rate carriage 3 and a half rate carriage 4 are movably placed on the support plates 2p, and the carriages 3 and 4 are guided by the support plates 2p so as to move in the longitudinal direction of the casing 2. Also, a platen glass (not shown) is mounted on the upper surface of the casing 2, and originals are placed on this platen glass. A light source lamp 5, such as a fluorescent lamp or the like is mounted on the full rate carriage 3, and the original is irradiated by this light source lamp 5. Further, an image focusing lens 6 and a photoelectric converter device 7, such as a CCD (Charged Coupled Device), are provided at appropriate positions on the bottom plate 2c of the casing 2. A left-end wall 2d and a right-end wall 2e are provided on bottom plate 2c and are connected to the side walls 2a and 2b.

A first reflector (not shown) is provided on the full rate carriage 3 and a second reflector and a third reflector (also not shown) are conventionally provided on the half rate carriage 4. The light beams emitted from the light source lamp 5 and reflected onto the original, is reflected in sequence at the first reflector, and then at second reflector and the third reflector. The light beams are then transmitted through the image focusing lens 6 and then made incident on the photoelectric converter device 7. An optical path is thus formed from the point where the light beams reflected on the original is reflected by the first reflector and the second and third reflectors, to the point where the light beams reach the photoelectric converter device 7. When the image information on the original is to be obtained, the entire area of the original must be irradiated. Thus, the full rate carriage 3 is movable along the entire area of the platen glass. The above optical path from the original to the photoelectric converter device 7 should be kept at a constant length even though the full rate carriage 3 moves. For this reason, the optical path can be kept at a constant length by synchronizing the movement of the half rate carriage 4 with that of the full rate carriage 3 which is set to almost half of the movement of the full rate carriage 3.

FIGS. 12 to 16 show the structure of the casing 2. FIG. 12 is a top plan view, FIG. 13 is a front view, FIG. 14 is a back view, FIG. 15 is a left-side view and FIG. 16 is a right-side view.

The walls 2a, 2b, 2d, and 2e respectively are provided along the periphery of the bottom plate 2c of the casing 2. A pair of hinge templates 2f is provided at the back surface side of the casing 2. On the hinge templates 2f are provided hinges for supporting a cover (not shown) which covers the platen glass (not shown) so that the cover is capable of being pivoted between open and covering positions. The bottom plate 2c is made to project towards the back surface side so as to form a receiving plate portion 2g. Ribs 2h (FIG. 14) are mounted on the receiving plate portion 2g and the hinge templates 2f, and the ribs 2h carry the load exerted on the hinge 2f.

The casing 2 described above is comprised of plate members which are appropriately configured and bent to form the walls 2a, 2b, 2d, and 2e, and the bottom plate 2c, hinge templates 2f, and ribs 2h respectively. These plate members are connected using fixing screws for assembly.

In the casing structure of the image reader of the prior art which was described above, because fixing screws are used to assemble the casing 2, the assembly work is labor intensive. Moreover, since a large number of fixing screws are used, managing the component parts is troublesome and along with the difficulty of assembly, there is also the possibility that the cost may be high.

Further, the image reader 1 is usually installed to copying machines, scanners and the like. As a result, the controlling means for the image reader 1 has to be mounted to the main body of the copying machine. That is, an image reader 1 exclusively for a copying machine is installed to a copying machine, an image reader 1 exclusively for a printer is installed to a printer, and an image reader 1 for connection to a personal computer is installed. Each image reader 1 is for exclusive use and thus, it is difficult for example, to use an image reader 1 which is for a copying machine with a scanner instead.

### SUMMARY OF THE INVENTION

An object of the present invention is to provide a casing structure of an image reader in which the work of assembly is simplified, and which carries control means and the like, and which can also be diversely used with each of the various image processing devices.

As the technical means for achieving this object, according to a first aspect of the present invention, there is provided a casing structure of an image reader, in which the image reader comprises a carriage which moves along an original placed on a platen. glass, and on the carriage is mounted a light source lamp whose light beams are moved along the original such that the original is sequentially irradiated, and the light beams reflected on the original is picked up so that an image formed on the original is read. The casing structure of the image reader has a carriage accommodated therein and a platen glass mounted on the upper portion of the casing structure, wherein the casing is formed by the plate members being welded together, and those portions for which it is necessary to carry out adjustments for mounting are fixed to the casing with fixing screws.

At times the accuracy of the dimensions of the casing which has been assembled may be insufficient. For this reason, for those parts which require high dimensional accuracy, adjustments at the time of mounting are carried out by using fixing screws for mounting. For example, the original which is placed on the platen glass must be set at a predetermined position. Thus, the member which fixes the part which carries out the positioning of the original is mounted such that adjustment of the position for the mounting can be carried out by using fixing screws.

According to another aspect of the present invention, there is provided a casing structure of an image reader, in which the image reader comprises a carriage which moves along an original placed on a platen glass, and on the carriage is mounted a light source lamp whose light beams are moved along the original such that the original is sequentially irradiated, and the light beams reflected on the original is picked up so that an image formed on the original is read. The casing structure of the image reader has a carriage accommodated therein and a platen glass mounted on the upper portion. A secondary casing is provided beneath the main casing which accommodates the carriage and the like, and the secondary casing accommodates predetermined drive means such as control means and the like.

Because predetermined driving means such as a power circuit and a control circuit which are necessary for driving the devices are stored in secondary casing, this image reader can operate independently even without a copying machine or the like being installed. As a result, this image reader can be used diversely for particular devices such as printers and scanners.

Further, in the casing structure of an image reader, the main casing and the secondary casing are formed by the respective plate members being welded together, and then the main casing and the secondary casing are welded together, and those members for which it is necessary to carry out adjustments for mounting are fixed to the main casing with fixing screws.

Because the main casing and the secondary casings are welded structures, the work of assembly is reduced, and the structure is made solid. In addition, the necessary parts can be mounted with a predetermined accuracy since they are mounted with fixing screws.

According to still another aspect of the present invention, there is provided a casing structure of an image reader, in which the image reader comprises a carriage which moves along an original placed on a platen glass, and on the carriage is mounted a light source lamp whose light beams are moved along the original such that the original is sequentially irradiated, and the light beams reflected on the original is picked up the photoelectric converter device so that an image formed on the original is read. The casing structure of the image reader has a carriage and a photoelectric converter device accommodated therein and a platen glass mounted on the upper portion. A secondary casing is provided beneath a main casing which accommodates the carriage and the like, and the secondary casing accommodates predetermined drive means such as control means and the like, and a through-hole which is a part of the bottom plate of the main casing is formed in the vicinity of the photoelectric converter device, and a harness and the like which extend from the photoelectric converter device are passed through the thorough-hole and led to the inside of the secondary casing.

In the image reader of the prior art, the control means and the like are placed on the main body apparatus such as a copying machine, and cassettes for printing paper and the like are disposed under the image reader. As a result, a harness which extends from the photoelectric converter device and the cable which extends from the drive motor of the carriage are passed through a side wall of the casing and pulled to the outside, and then connected to the control means of the apparatus main body or the like. However, the harness which extends from the photoelectric converter device to the side wall can obstruct the movement of the carriage. Thus the harness must be held in place using appropriate means and since the harness is sometimes forcibly bent or carelessly pulled, there is the possibility that it may be disconnected from the photoelectric converter device. However, since the secondary casing is provided under the main casing, the harness and the like can be passed through the bottom plate of the main casing and extended to the secondary casing. Thus even if the harness is pulled, it will not be disconnected.

In this casing structure of an image reader, a harness bracket for holding the harness is mounted from the main casing side, so as to be removable from the edge portion of the through-hole. It is sufficient for the secondary casing to have a thickness such that it can accommodate fixed driving means, and such that the circuit board onto which these driving means and the like are installed can be inserted through and pulled out from the board, but the user's hands cannot be put into the secondary casing. As a result, the harness which is connected to the photoelectric converter device cannot be appropriately handled. However, if the harness is held by a harness bracket, and the harness bracket is fixed to the bottom plate of the main casing, the harness can be appropriately handled and it is prevented from obstructing the movement of the carriage and from being forcibly pulled.

These and other features, objects and advantages of the present invention will become apparent upon reading the following description thereof together with reference to the accompanying drawings.

### BRIEF DESCRIPTION OF THE DRAWINGS

FIG. 1 is an exploded view of a casing having the structure of the present invention;

FIG. 2 is a top plan view of the casing having the structure according to the present invention;

FIG. 3 is a front view of the casing shown in FIG. 2;

FIG. 4 is a back view of the casing shown in FIG. 2;

FIG. 5 is a left-side view of the casing shown in FIG. 2;

FIG. 6 is a right-side view of the casing shown in FIG. 2;

FIG. 7 is a top plan view of a casing, showing the structure for holding a harness and a cable in the casing according to the present invention;

FIG. 8 is a left-side view of the casing shown in FIG. 7;

FIG. 9 is a fragmentary top plan view of the structure for holding the harness and the like shown in FIG. 7;

FIG. 10 is a left-side view of the structure shown in FIG. 9;

FIG. 11 is a perspective view for explaining the schematic structure of an image reader;

FIG. 12 is a plan view showing the structure of a prior art casing used in a conventional image reader;

FIG. 13 is a front view of the casing shown in FIG. 12;

FIG. 14 is a back view of the casing shown in FIG. 12;

FIG. 15 is a left-side view of the casing shown in FIG. 12; and

FIG. 16 is a right-side view of the casing shown in FIG. 12.

### DETAILED DESCRIPTION OF THE PREFERRED EMBODIMENTS

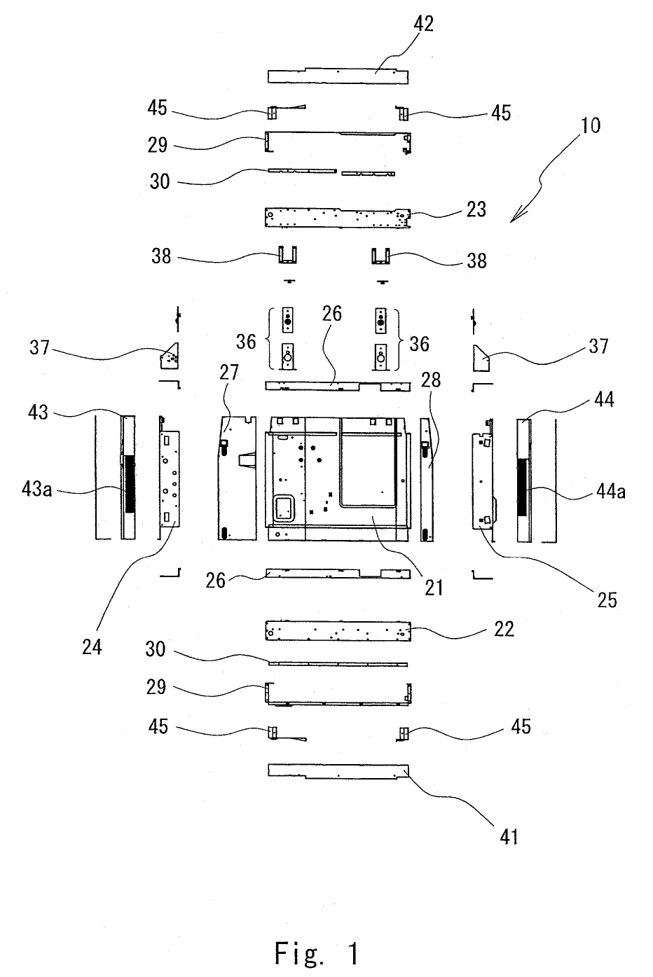

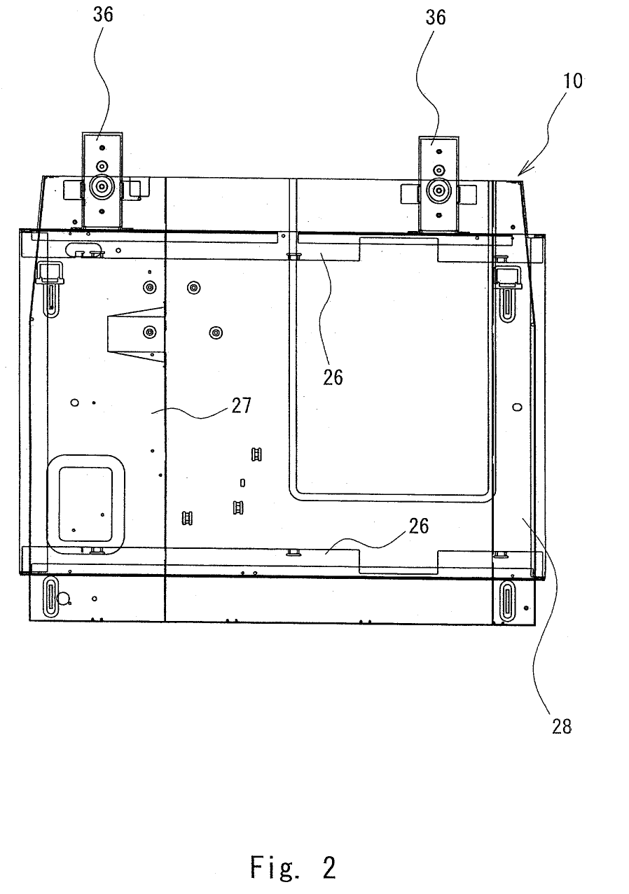

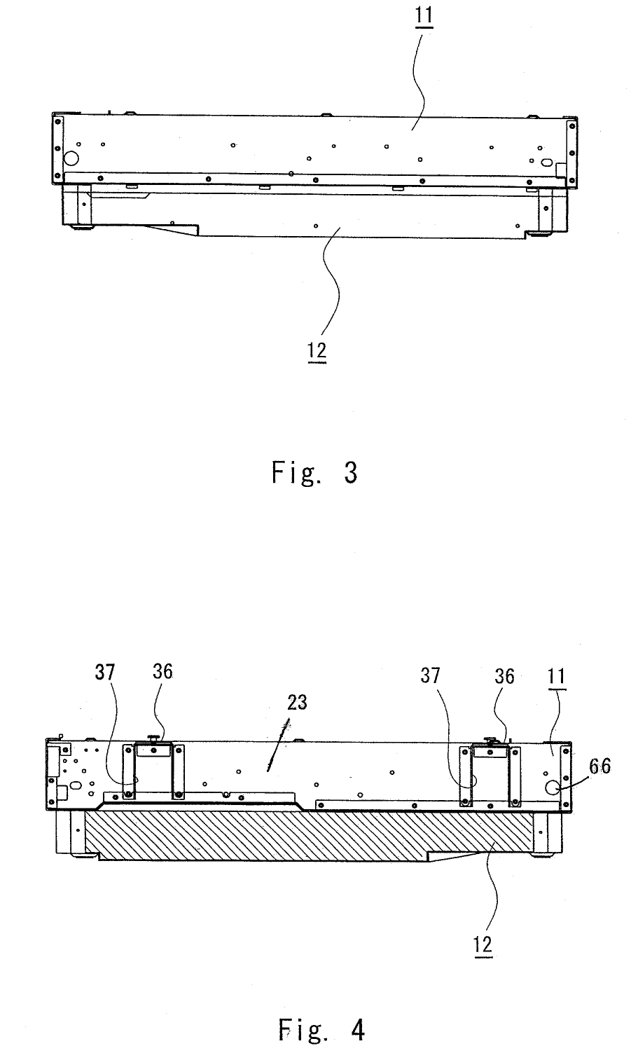

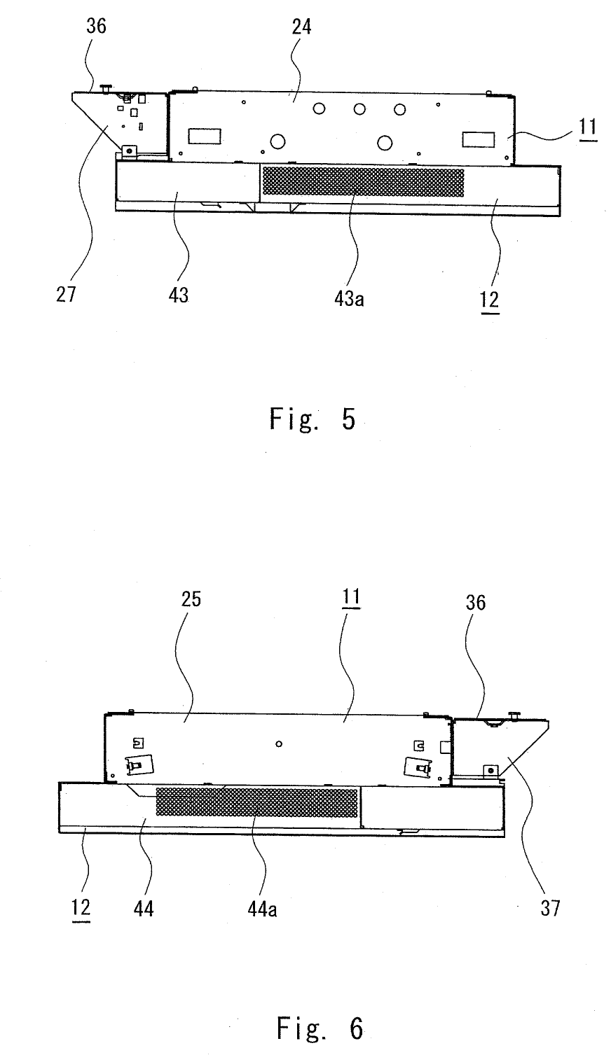

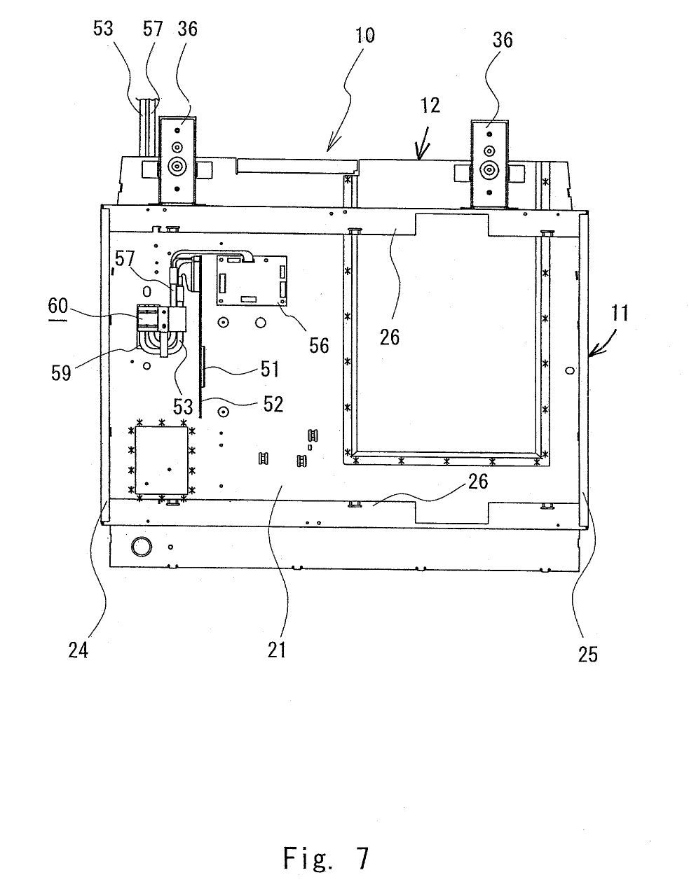

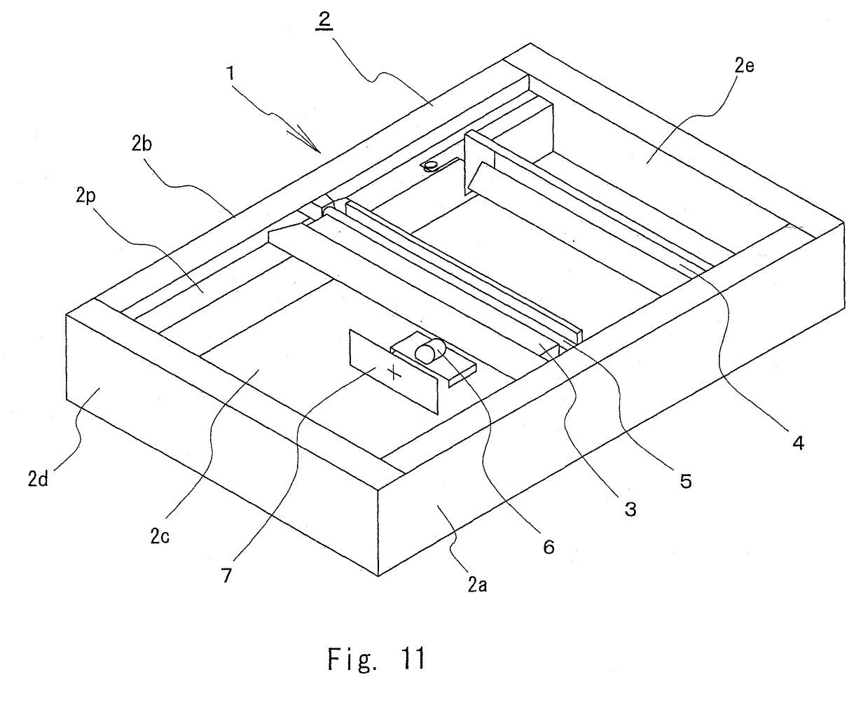

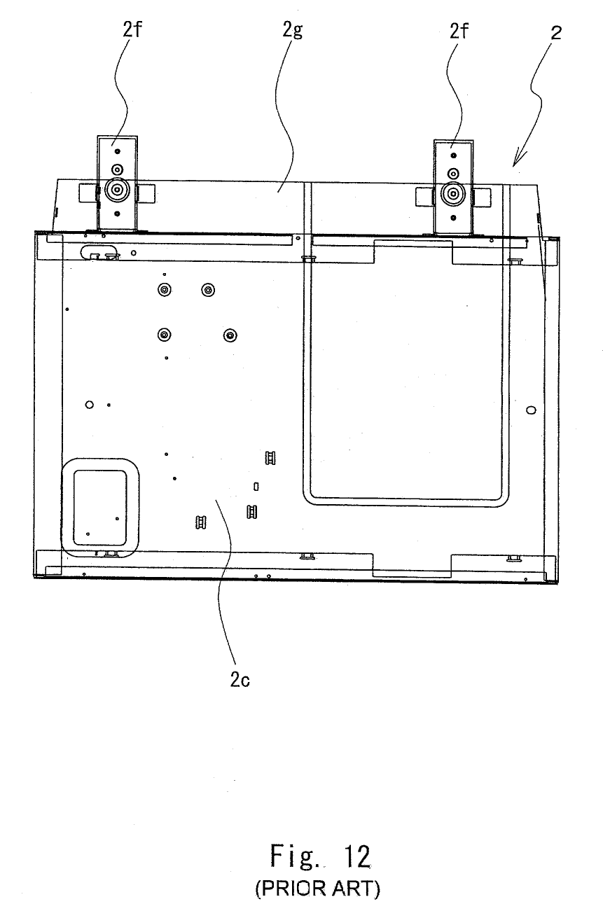

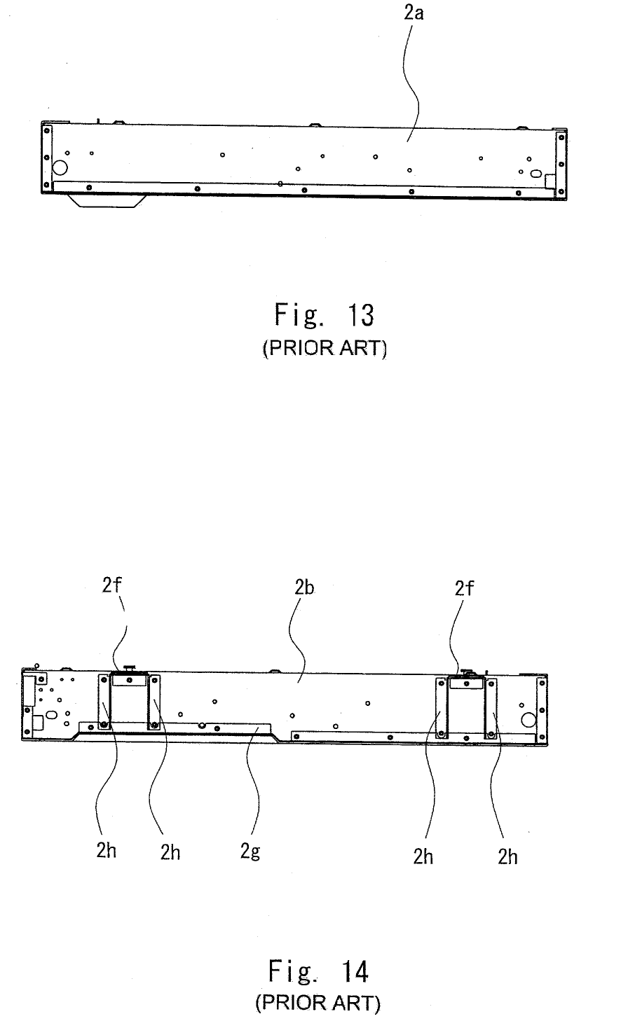

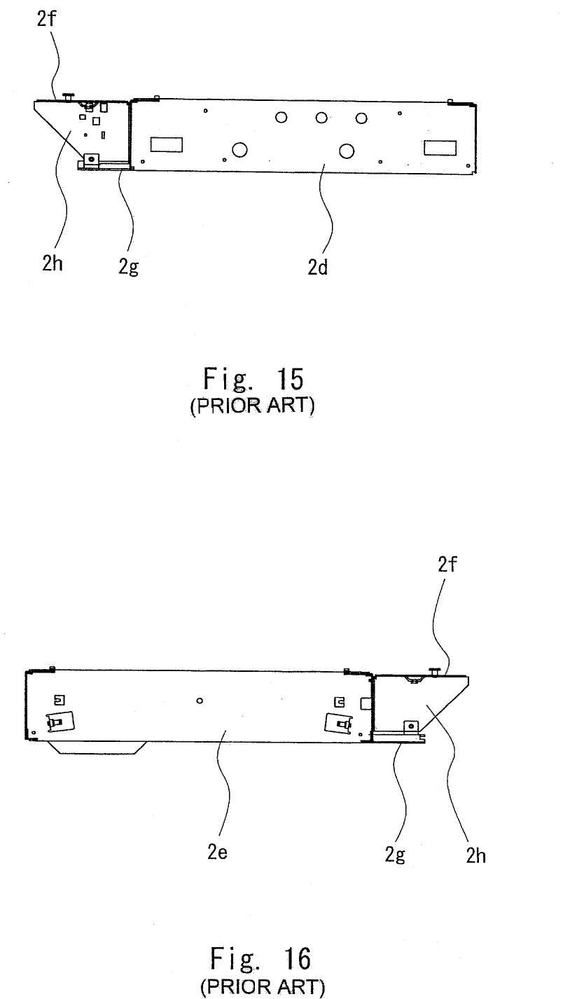

A casing 10 of an image reader having the structure according to the present invention is shown in FIGS. 2 to 6 and comprises a main casing 11 (FIGS. 3-6) which accommodates the main component parts of the image reader such as a full rate carriage 3, a half rate carriage 4, a photoelectric converter device 7 and the like (FIG. 11). A secondary casing 12 is provided under the main casing 11 and accommodates mainly control means of the image reader. FIG. 1 shows the individual component metal plates of the casing 10 prior to assembly. A front-side wall plate 22 and a back-side wall plate 23 are mounted at the front and the rear respectively, of a substantially rectangular-shaped bottom plate 21, from an edge portion of the bottom plate 21 to an appropriately positioned portion in the inside thereof. At the left and right vicinities, respectively, of the bottom plate 21, a left-side wall plate 24 and a right-side wall plate 25 are mounted. Glass support planks 26 on which a platen glass (not shown) is placed, is mounted along the front-side wall plate 22 and the back-side wall plate 23 on the upper end portions of the wall plates 22, 23, 24 and 25. In addition, a regulating member mounting plate 27 for fixing the member which positions the platen glass is mounted so as to extend between the front-side wall plate 22 and the back-side wall plate 23 at the top end portion of the left-side wall plate 24. Conversely, an end portion receiving plate 28 which projects so as to abut an end portion of the platen glass and thereby positions the platen glass, and which extends between the front-side wall plate 22 and the back-side wall plate 23, is mounted at the top end portion of the right-side wall plate 25. A frame plate 29 is mounted on left, right and lower areas of the front-side wall plate 22 and the back-side wall plate 23, and an edge plate 30 is mounted at the upper area thereof.

A pair of plates for the hinge pedestal 36 on which hinge members (not shown) for opening/closing the cover (also not shown) are mounted, is mounted at the back-side wall plate 23. Rib plates 37 are mounted on the plates for the hinge pedestal 36 and on the portion of the bottom plate 21 which projects to the back-side. Further, a pedestal frame plate 38 is mounted on the board portions of the plates for the hinge pedestal 36.

A front-side secondary wall plate 41, a back-side secondary wall plate 42, a left-side secondary wall plate 43 and a right-side secondary wall plate 44, which form the secondary casing 12 and are mounted in the lower vicinity portion of the bottom plate 21. It is noted that air holes 43a and 44a are formed in the left-side secondary wall plate 43 and the right-side secondary wall plate 44 respectively. In addition, holding plates 45 are provided at edge portions of the front-side secondary wall plate 41 and the back-side secondary wall plate 42.

Also, the main casing 11 and the secondary casing 12 of the integrated casing 10 are formed by each of the members mentioned above being welded together arranged as described. Alternatively, some of the members may be mounted by fixing screws. For example, the bottom plate 21, the edge plate 30, the frame plate 29, the holding plate 45, the front-side secondary wall plate 41, the left-side wall plate 24, the right-side wall plate 25, left-side secondary wall plate 43 and the right-side secondary wall plate 44 may be formed by welding, while the other members are fixed with fixing screws to the welded structure formed of those previously welded parts.

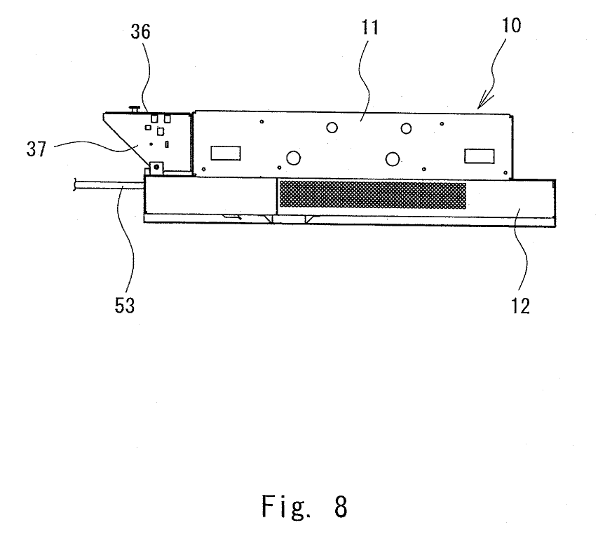

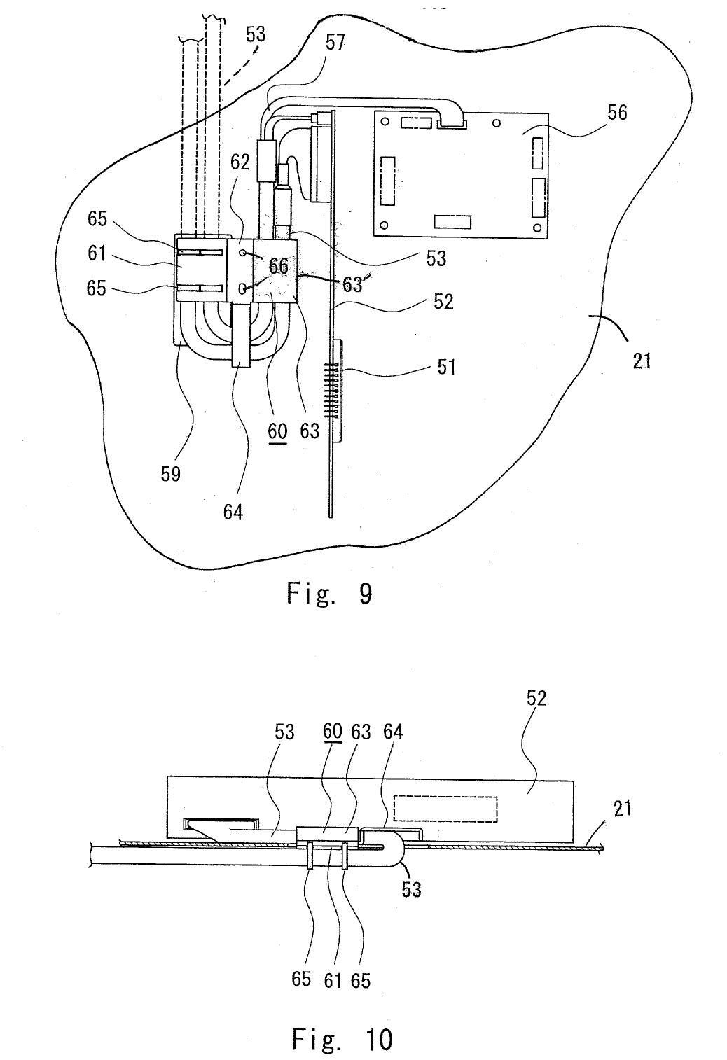

As shown in this embodiment, the casing 10 is formed such that the secondary casing 12 is mounted under the main casing 11, and a through-hole 59 (FIGS. 8 and 9) is formed in the bottom plate 21 of the main casing 11, and the wire harness 53 and the like of the photoelectric converter device which is accommodated in the main casing 11, can be pulled into the secondary casing 12 through this through-hole. As a result, a through-hole 66 (FIG. 4) is also formed in one of the wall plates 22, 23, 24 or 25, and disconnection of the harness as a result of the harness being carelessly pulled as occurs when the harness is pulled from the main casing 11 to the outside, is prevented.

FIGS. 7 to 10 illustrate a structure applied when the harness and the like of the photoelectric converter device is pulled into the secondary casing 12, through the through-holes formed in the bottom plate 21 of the main casing 11. A CCD board 52 having assembled thereon a CCD 51 as the photoelectric converter device is disposed at an appropriate position on the bottom plate 21 of the main casing 11. A harness 53 extends from the CCD board 52, and is connected to a control circuit (not shown), which is disposed inside the secondary casing 12. In addition, cables 57 extend from a carriage drive motor (not shown) which moves the carriage and a power circuit 56 of the CCD 51 which are accommodated in the main casing 11, are pulled into the secondary casing 12 and connected to the main power source.

A through-hole 59 is formed through the bottom plate 21 in the vicinity of the CCD board 52. The harness 53 and the cable 57 are held by a harness bracket 60, and pulled through the through-hole 59 into the secondary casing 12.

The harness bracket 60, in a plan view thereof, includes: a lower guide 61 (FIG. 9) which is configured so as to plug the thorough-hole 59; a bracket anchor section 62 which is adjacent to the lower guide 61 and fixes by screws the harness bracket 60 to the edge portion of the through-hole 59. Bracket 60 also includes an upper guide 63 which nips the bracket anchor section 62 and is formed at the opposite side of the lower guide 61. A harness reversed portion 64 projects from the end of the bracket anchoring section 62. The bracket anchor section 62 is superposed on the upper surface of the bottom plate 21, and fixing screws are inserted through the harness bracket 60 so as to fix the harness bracket 60 to the bottom plate 21. An air space is formed at an appropriate distance between the upper surface of the bottom plate 21 and the upper guide 63, as seen in FIG. 10. The harness 53 and the cable 57 are passed through this air space, and also the harness 53 and the cable 57 are restrained at an appropriate length thereof. Also, the front end portion 63′ (FIG. 9) of the upper guide 63 is bent toward the lower direction so that the harness 53 and the like do not become disconnected. When the lower guide 61 is positioned in the thorough-hole 59 as shown in FIG. 10, the lower surface of the lower guide portion 61 is at a slightly lower position than the lower surface of the bottom plate 21. The harness 53 and the cable 57 are inserted through the lower side of the lower guide portion 61, and at the same time the harness 53 and the like are held by the anchor brackets 65. In addition, the harness reversed portion 64 guides the path of the harness 53 and the like from the upper side to the lower side of the bottom plate 21, and also restricts the harness 53 and the like so that they do not come off in the upper direction.

When the harness 53 and the like are held by the harness bracket 60, the harness 53 and the like are held by the anchor bracket 65 to the lower guide section 61. When the harness 53 and the like are in a state of being held by the upper guide section 63 after passing through the harness reversed section 64, the harness bracket 60 is fixed to the bottom plate 21 by fixing screws 66 (FIG. 9).

When the harness bracket 60 is fixed to the bottom plate 21, the work can be carried out from the side of the main casing 11. For this reason, when the harness bracket 60 is fixed to a center section of the bottom plate 21, even if the user's hands cannot be inserted into the secondary casing 12, the harness 53 and the like can be securely held. For this reason, the harness 53 and the like can be prevented from being bent and from interfering with the other parts. Furthermore, as shown in FIGS. 7 and 8, when the harness 53 and the like are pulled to the back-side of the casing 10, even if they are pulled unnecessarily, the harness 53 and the cable 57 will not be disconnected due to the harness bracket 60 resisting the pulling force.

As described above, according to the casing structure of the image reader of the present invention, the entire casing or a portion of the casing is welded, and thus the assembly work is simplified. Moreover, for the members for which accurate mounting must be carried out, by using fixing screws, adjustment of the mounting position can be carried out. Thus, there are no obstacles to the image reader carrying out the desired functions.

Further, according to the casing structure of the image reader in which a secondary casing is provided under the main casing in which the carriage and the like of the casing are stored, and predetermined driving means such as control means and the like are stored in the secondary casing, and the image reader can operate independently and diverse use of the image reader with copying machines and scanners is possible. Still further, according to the casing structure of the image reader in which the main casing and the secondary casing are both welded structures, the work of assembly can be reduced.

In addition, according to the casing structure of the image reader in which a thorough-hole is formed in the vicinity of the photoelectric converter device which is a part of the bottom plate of the main casing, a harness and the like which extend from the photoelectric converter device and the like are passed through the thorough-hole and led to the inside of the secondary casing, since it is not necessary to extend the harness and the like from the photoelectric converter device to the side direction, even if the harness and the like are unnecessarily pulled, the cutting off of the connection with the photoelectric converter device is prevented.

Further, according to the casing structure of the image reader in which the harness bracket which holds the harness can be mounted from the main casing side so as to be removable from the edge portion of the thorough-hole, since the work of holding the harness and the like can be carried out from the side of the main casing, there is no need for the hands of the user to be put inside the main casing. As a result, the secondary casing can be made extremely thin and there is thus no need for the image reader to be made extremely large.

It will become apparent to those skilled in the art that various modifications to the preferred embodiment of the invention as described herein can be made without departing from the spirit or scope of the invention as defined by the appended claims.

What is claimed is:

1. A casing for an image reader, which includes a carriage which moves along an original placed on a platen glass, and on the carriage is mounted a light source lamp whose light beams are moved along the original such that the original is sequentially irradiated, and the light beams reflected on the original is picked up so that an image formed on the original is read, the casing structure comprising:
a plurality of plate members welded together; and
fixing screws for mounting elements for which it is necessary to carry out adjustments.

2. A casing for an image reader comprising:
a main casing for housing carriage which moves along an original placed on a platen glass, and on the carriage is mounted a light source lamp whose light beams are moved along the original such that the original is sequentially irradiated, and the light beams reflected on the original is picked up so that an image formed on the original is read; and
a secondary casing positioned beneath said main casing which accommodates predetermined elements, such as control means.

3. The casing for an image reader as defined in claim 2, wherein the main casing and the secondary casing are formed by a plurality of plate members welded together, and said main casing and said secondary casing are welded together.

4. The casing for an image reader as defined in claim 3 and further including fixing screws for mounting those members for which it is necessary to carry out adjustments to the main casing.

5. A casing for an image reader comprising:
a main casing having a bottom plate and walls for housing a carriage which moves along an original placed on a platen glass, and on the carriage is mounted a light source lamp whose light beams are moved along the original such that the original is sequentially irradiated, and the light beams reflected on the original are captured in a photoelectric converter device so that an image formed on the original is read;
a secondary casing positioned beneath said main casing wherein said secondary casing accommodates predetermined drive means such as control means and the like, and wherein a thorough-hole is formed in said bottom plate of said main casing in the vicinity of the photoelectric converter device; and
a harness which extends from the photoelectric converter device is passed through said thorough-hole and led to the inside of the secondary casing.

6. The casing for an image reader as defined in claim 5, and further including a harness bracket for holding the harness to said main casing, so as to be removable from an edge of the thorough-hole.

7. The casing for an image reader as defined in claim 6, wherein said main and secondary casings are welded.

8. A casing for an image reader, in which the image reader comprises a carriage which moves along an original placed on a platen glass, and on the carriage is mounted a light source lamp whose light beams are moved along the original such that the original is sequentially irradiated, and the light beams reflected on the original is picked up so that an image formed on the original is read, and the casing structure of the image reader has a carriage accommodated therein and a platen glass mounted on the upper portion of the casing structure, wherein the improvement comprises:
the casing is formed by plate members welded together; and
those portions of the image processor for which it is necessary to carry out adjustments for mounting are fixed to the casing with fixing screws.

9. A casing for an image reader including a main casing, in which the image reader comprises a carriage which moves along an original placed on a platen glass, and on the carriage is mounted a light source lamp whose light beams are moved along the original such that the original is sequentially irradiated, and the light beams reflected on the original is picked up so that an image formed on the original is read, and the main casing of the image reader has a carriage accommodated therein and a platen glass mounted on the upper portion thereof, wherein the improvement comprises:
a secondary casing positioned beneath said main casing which accommodates the carriage and the like; and
said secondary casing accommodates predetermined elements such as control means.

10. The casing for an image reader as defined in claim 9, wherein said main casing and said secondary casing are formed by the respective plate members welded together.

11. The casing for an image reader as defined in claim 10 wherein said main casing and said secondary casing are welded together.

12. The casing for an image reader as defined in claim 11 and further including fixing screws for mounting those members for which it is necessary to carry out adjustments to the main casing.

13. A casing for an image reader including a main casing for an image reader comprising a carriage which moves along an original placed on a platen glass, and on the carriage is mounted a light source lamp whose light beams are moved along the original such that the original is sequentially irradiated, and the light beams reflected on the original is captured in a photoelectric converter device so that an image formed on the original is read, and the main casing of the image reader has the carriage and the photoelectric converter device accommodated therein and a platen glass mounted on the upper portion thereof, wherein the improvement comprises:
a secondary casing positioned beneath said main casing, which secondary casing accommodates predetermined elements such as control means and wherein a thorough-hole is formed in the bottom plate of the main casing in the vicinity of the photoelectric converter device; and
a harness extends from the photoelectric converter device and is passed through the thorough-hole and led to the inside of said secondary casing.

14. The casing for an image reader as defined in claim 13, and further including a harness bracket for removably holding the harness on the main casing adjacent the thorough-hole.
